(19) United States
(12) Patent Application Publication
(10) Pub. No.: US 2021/0080022 A1
(43) Pub. Date: Mar. 18, 2021

(54) VALVE DEVICE

(71) Applicant: DENSO CORPORATION, Kariya-city, Aichi-pref. (JP)

(72) Inventors: Shinji KAWADA, Kariya-city (JP); Seiji TATEISHI, Kariya-city (JP); Hikaru OTSUKA, Kariya-city (JP); Hiroto INOUE, Kariya-city (JP); Shin KUWATA, Kariya-city (JP); Tetsuya ITO, Kariya-city (JP); Shinji HASHIMOTO, Kariya-city (JP)

(73) Assignee: DENSO CORPORATION, Kariya-city, Aichi-pref. (JP)

(21) Appl. No.: 17/056,056

(22) PCT Filed: Jun. 5, 2019
(86) PCT No.: PCT/JP2019/022251

§ 371 Date: Nov. 17, 2020

(30) Foreign Application Priority Data
Jun. 7, 2018 (JP) 2018-109449

(51) Int. Cl. F16K 31/04

(52) U.S. Cl. CPC F16K 31/046; F25B 41/062

(57) ABSTRACT

A valve device includes a valve, a driving device, and a transmission unit. The valve changes a circulation mode of refrigerant flowing through a circulation path of a refrigeration cycle system. The driving device drives the valve. The driving device includes a housing and an electric driving unit as a drive source. The transmission unit is arranged in a driving transmission path extending from the electric driving unit to the valve, and changes a speed of rotation generated by driving of the electric driving unit. The transmission unit is entirely or partially arranged in the housing that is partitioned from the circulation path in a liquid-tight manner.

### CROSS-REFERENCE TO RELATED APPLICATIONS

The present application is based on Japanese Patent Application No. 2018-109449 filed on Jun. 7, 2018, the entire contents of which are incorporated herein by reference.

### TECHNICAL FIELD

The present disclosure relates to an electric valve device including an electric driving unit.

### BACKGROUND ART

Patent Document 1 discloses an example of a valve device, such as a four-way valve, for use with a refrigeration cycle device. The valve device includes a motor serving as an electric driving unit and a speed reduction unit that reduces the speed of the rotation produced by a rotor of the motor and increases the torque. The valve device drives a valve body with an output shaft of the speed reduction unit.

### PRIOR ART DOCUMENT

### Patent Document

Patent Document 1: Japanese Laid-Open Patent Publication No. 11-13919

### SUMMARY OF THE INVENTION

When a transmission unit including a planetary gear train such as that of Patent Document 1 is entirely or partially arranged in a space exposed to refrigerant, the water in the refrigerant may cause corrosion and adversely affect smooth movement.

The inventors of the present invention have developed a valve device including a transmission unit that can be stably used over a long period of time.

It is an object of the present disclosure to provide an electric valve device that can be stably used over a long period of time.

A valve device according to one aspect includes a valve, driving device, and a transmission unit. The valve changes a circulation mode of refrigerant flowing through a circulation path of a refrigeration cycle system. The driving device drives the valve. The driving device includes a housing and an electric driving unit as a drive source. The transmission unit is arranged in a driving transmission path extending from the electric driving unit to the valve. The transmission unit changes the speed of rotation generated by driving of the electric driving unit. The transmission unit is entirely or partially arranged in the housing that is partitioned from the circulation path in a liquid-tight manner.

With the above configuration, the components of the transmission unit are entirely or partially arranged inside the housing of the driving device partitioned in a liquid-tight manner from a refrigerant passage. Thus, the components inside the housing are not exposed to refrigerant. This avoids corrosion of the components inside the housing that may be caused by water in the refrigerant and would adversely affect smooth movement of the components. Thus, the valve device can be used stably over a long period of time.

### BRIEF DESCRIPTION OF THE DRAWINGS

The objective, other objectives, features, and advantages of the present disclosure will be clear in the detailed description below with reference to the accompanying drawings.

FIG. 1 is a schematic diagram showing a refrigeration cycle system including a valve device according to one embodiment.

FIG. 2 is a schematic diagram showing an expansion valve device.

FIGS. 3A to 3C are plan views showing first and second magnetic speed reduction units (driving rotating body, magnetic transmitting member, and driven rotating body).

FIGS. 4A to 4C are net diagrams illustrating the operations of the first and second magnetic speed reduction units.

FIG. 5 is a cross-sectional view showing the structure of a speed reduction unit (magnetic speed reduction unit) according to a modification.

FIG. 6 is a cross-sectional view showing the structure of a speed reduction unit (reduction gear unit) and the periphery of the speed reduction unit according to a modification.

### MODES FOR CARRYING OUT THE INVENTION

One embodiment of the valve device will now be described with reference to the drawings. The drawings may exaggerate or simplify part of configurations for the sake of convenience. The dimensions of parts may be different from reality.

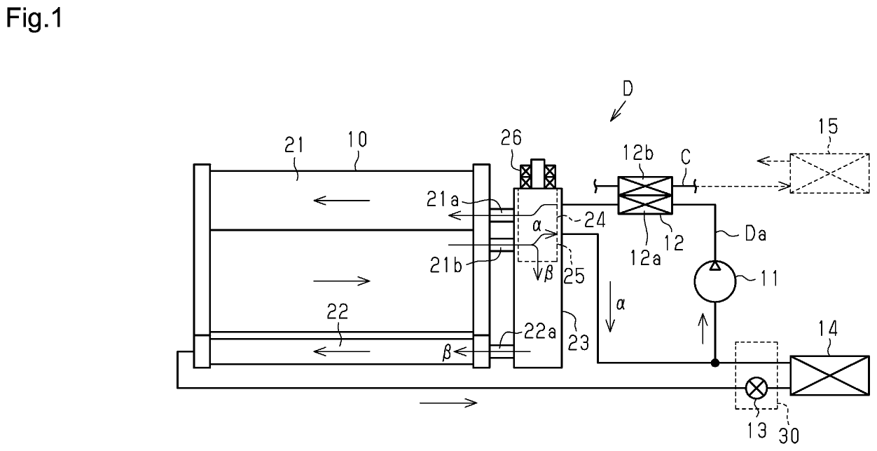

As shown in FIG. 1, a heat exchanger 10 of the present embodiment is used with a refrigeration cycle system D (heat pump cycle system) that air-conditions an electric motor vehicle (hybrid vehicle, electric vehicle). A vehicle air conditioner including the refrigeration cycle system D is configured to switch between a cooling mode for sending air, cooled by an evaporator 14, to a passenger compartment and a heating mode for sending air, heated by a heater core 15, to the passenger compartment. The refrigeration cycle system D includes refrigerant circuitry Da that is configured to switch between a circuit for the cooling mode (cooling path a) and a circuit for the heating mode (heating path (3). The refrigerant circulated through the refrigerant circuitry Da of the refrigeration cycle system D may be an HFC refrigerant or an HFO refrigerant. The refrigerant preferably contains oil to lubricate a compressor 11.

The refrigerant circuitry Da of the refrigeration cycle system D includes the compressor 11, a water-cooled condenser 12, the heat exchanger 10, an expansion valve 13 serving as a valve (expansion valve device 30 serving as valve device), and the evaporator 14.

The compressor 11 is an electric compressor arranged in an engine compartment outside the passenger compartment. The compressor 11 draws in and compresses refrigerant in the gaseous phase and discharges the gaseous-phase refrigerant, which has been superheated (high temperature and high pressure), into the water-cooled condenser 12. The gaseous-phase refrigerant having high temperature and high pressure, which has been discharged from the compressor 11, enters the water-cooled condenser 12. The compression mechanism of the compressor 11 may be selected from various types of compression mechanisms such as a scroll compressor, a vane compressor, and the like. The compressor 11 is configured to control its refrigerant displacement.

The water-cooled condenser 12 is a known heat exchanger. The water-cooled condenser 12 includes a first heat exchanging portion 12a arranged in the refrigerant circuitry Da and a second heat exchanging portion 12b arranged in a coolant circuit C of a coolant circulation device. The heater core 15 is also arranged in the circuit C. The water-cooled condenser 12 exchanges heat between the gaseous-phase refrigerant flowing through the first heat exchanging portion 12a and the coolant flowing through the second heat exchanging portion 12b. In other words, the water-cooled condenser 12 heats the coolant in the second heat exchanging portion 12b with the heat of the gaseous-phase refrigerant in the first heat exchanging portion 12a and cools the gaseous-phase refrigerant in the first heat exchanging portion 12a. The water-cooled condenser 12 serves as a heat dissipator that dissipates the heat of the refrigerant, which has been discharged from the compressor 11 into the first heat exchanging portion 12a, through the coolant and the heater core 15 to the air blown by the vehicle air conditioner.

The gaseous-phase refrigerant that has passed through the first heat exchanging portion 12a of the water-cooled condenser 12 enters the heat exchanger 10 via an integrated valve device 24 that will be described later. The heat exchanger 10 is an exterior heat exchanger arranged toward the front of the engine compartment outside the passenger compartment. The heat exchanger 10 exchanges heat between the refrigerant flowing though the heat exchanger 10 and the air outside the passenger compartment (ambient air) delivered by a fan (not shown).

Specifically, the heat exchanger 10 includes a first heat exchanging portion 21 and a second heat exchanging portion 22 that serves as a supercooling device. The heat exchanger 10 further includes a liquid reservoir 23 formed integrally with an integrated valve device 24. The liquid reservoir 23 is connected to the first and second heat exchanging portions 21, 22, and the integrated valve device 24 is arranged in the liquid reservoir 23. The first heat exchanging portion 21 includes an inlet path 21a and an outlet path 21b that are connected to the integrated valve device 24. The second heat exchanging portion 22 includes an inlet path 22a connected to the liquid reservoir 23 and the integrated valve device 24.

The first heat exchanging portion 21 serves as a condenser or evaporator in accordance with the temperature of the refrigerant flowing therethrough. The liquid reservoir 23 is configured to separate a liquid-phase refrigerant from a gaseous-phase refrigerant and store the separated liquid-phase refrigerant in the liquid reservoir 23. The second heat exchanging portion 22 exchanges heat between the ambient air and the liquid-phase refrigerant from the liquid reservoir 23 to further cool the liquid-phase refrigerant to increase the degree of supercooling and sends the heat-exchanged refrigerant to the expansion valve 13. The first heat exchanging portion 21, the second heat exchanging portion 22, and the liquid reservoir 23 are connected to one another by, for example, bolts to be formed integrally.

The integrated valve device 24 includes a valve main body 25 arranged inside the liquid reservoir 23 and an electric driving unit 26 for driving the valve main body 25. The integrated valve device 24 is an electric valve device that uses a motor (stepping motor or the like) as the electric driving unit 26. The integrated valve device 24, in the heating mode, forms a heating path a that connects the first heat exchanging portion 12a of the water-cooled condenser 12 to the inlet path 21a of the first heat exchanging portion 21 and connects the outlet path 21b of the first heat exchanging portion 21 directly to the compressor 11. The integrated valve device 24, in the cooling mode, forms a cooling path β that connects the first heat exchanging portion 12a of the water-cooled condenser 12 to the inlet path 21a of the first heat exchanging portion 21 and connects the outlet path 21b of the first heat exchanging portion 21 via the second heat exchanging portion 22, the expansion valve 13, and the evaporator 14 to the compressor 11. The integrated valve device 24, when stopped, closes all paths. The integrated valve device 24 operates the valve main body 25, which is driven by the electric driving unit 26, to switch among the stop, the heating mode, and the cooling mode.

The expansion valve 13 depressurizes and the liquid-phase refrigerant supplied from the heat exchanger 10. In the present embodiment, the expansion valve 13, which is a valve body, and an electric driving unit (motor) 42, which is configured to actuate the expansion valve 13, are integrated to form an electric expansion valve device 30. The structure of the expansion valve device 30 will be described in detail later. The expansion valve 13 depressurizes the low-temperature, high-pressure liquid-phase refrigerant and supplies the liquid-phase refrigerant to the evaporator 14.

The evaporator 14 is a heat exchanger for cooling that cools air delivered in the cooling mode. The liquid-phase refrigerant supplied by the expansion valve 13 to the evaporator 14 exchanges heat with the air around the evaporator 14 (inside duct of vehicle air conditioner). The heat exchange evaporates the liquid-phase refrigerant and cools the air around the evaporator 14. The refrigerant inside the evaporator 14 is sent to the compressor 11 and compressed by the compressor 11 again.

The structure of the expansion valve device 30 in the present embodiment will now be described in detail.

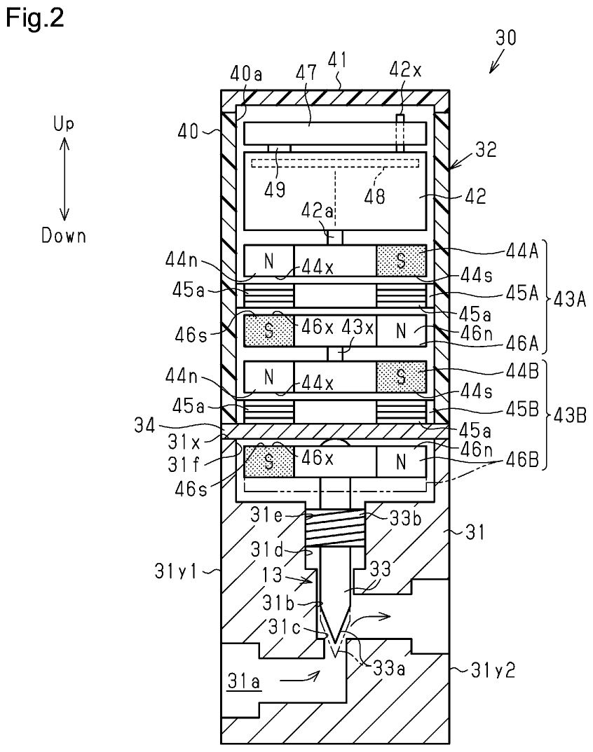

As shown in FIG. 2, the expansion valve device 30 includes a base block 31, the expansion valve 13 that is arranged in the base block 31, and a driving device 32 that is integrally fixed to the base block 31 to drive the expansion valve 13.

The base block 31 includes an inlet path 31a that allows refrigerant to flow from the second heat exchanging portion 22 to the evaporator 14. The inlet path 31a serves as part of a circulation path. The inlet path 31a has a passage shape that is circular in cross section. The base block 31, which is a substantially rectangular parallelepiped, includes an upper surface 31x to which the driving device 32 is fixed (base block 31 is located at lower side and driving device 32 is located at upper side). The inlet path 31a extends through the base block 31 from a side surface 31y1 at one side to a side surface 31y2 at the opposite side.

The inlet path 31a includes a vertical passage 31b that extends in the vertical direction orthogonal to the direction in which the inlet path 31a extends. The vertical passage 31b has an upper end that is connected to a valve accommodating hole 31d having a circular cross section. The valve accommodating hole 31d accommodates a valve body 33. The valve body 33 is a needle-shaped valve and includes a distal end 33a that is acute and directed downward. That is, the expansion valve 13 is formed by a needle valve. The valve body 33 is moved back and forth in its axial direction (vertical direction in FIG. 2) so that the distal end 33a opens and closes an opening 31c of the vertical passage 31b. The expansion valve 13 allows and blocks the circulation of refrigerant through the inlet path 31a and also adjusts the circulated amount in this manner.

The valve body 33 includes the distal end 33a, an external thread 33b located at an intermediate position, and a driven rotating body 46B located at the proximal end. The driven rotating body 46B forms part of a second magnetic speed reduction unit 43B as will be described later. The external thread 33b is fastened to an internal thread 31e provided on the inner surface of the valve accommodating hole 31d. The external thread 33b converts rotation of the valve body 33 into linear actions of the valve body 33 in the axial direction (vertical direction). The driven rotating body 46B is coaxially fixed to the proximal end of the valve body 33. The driven rotating body 46B is magnetically coupled to a driving rotating body 44B, which will be described later, by a magnetic transmission member 45B in a non-contact manner. The driving rotating body 44B is connected to an electric driving unit 42 by a first magnetic speed reduction unit 43A and driven by the electric driving unit 42. That is, when the electric driving unit 42 drives and rotates the first and second magnetic speed reduction units 43A, 43B, which, in turn, rotates the final-stage driven rotating body 46B, the valve body 33 is rotated and actuated accordingly. The first and second magnetic speed reduction units 43A, 43B each serve as a transmission unit (magnetic transmission unit). The external thread 33b and the internal thread 31e convert the rotation of the valve body 33 into linear actions of the valve body 33 in the axial direction, that is, opening and closing actions of the expansion valve 13.

A closure plate 34 for closing an opening 31f of the valve accommodating hole 31d is fixed to the upper surface 31x of the base block 31 by fastening screws (not shown). The closure plate 34 is shaped to be flat and made of metal (such as SUS). The closure plate 34 closes the opening 31f of the valve accommodating hole 31d in a liquid-tight manner and partitions the valve accommodating hole 31d, through which refrigerant flows, from the driving device 32. In other words, the closure plate 34 serves as a partition that closes the opening 31f of the valve accommodating hole 31d of the base block 31 in a liquid-tight manner. The closure plate 34 seals the opening 31f so that the refrigerant does not leak from the base block 31 to the outside (i.e, driving device 32).

The driving device 32 is fixed to the upper surface 31x of the base block 31 by attachment screws (not shown) with the closure plate 34 arranged between the driving device 32 and the base block 31. The driving device 32 includes a housing 40 having an opening 40a at its upper surface and a cover 41 that closes the opening 40a of the housing 40. The driving device 32 further includes the electric driving unit 42, the first magnetic speed reduction unit 43A, the driving rotating body 44B and magnetic transmission member 45B that are parts of the second magnetic speed reduction unit 43B, and a circuit board 47, all of which are accommodated in the housing 40. The first magnetic speed reduction unit 43A includes a driving rotating body 44A, magnetic transmission member 45A, and a driven rotating body 46A. The driven rotating body 46B of the second magnetic speed reduction unit 43B is arranged in the valve accommodating hole 31d outside the housing 40.

The electric driving unit 42, the driving rotating body 44A, the magnetic transmission member 45A, the driven rotating body 46A, the driving rotating body 44B, and the magnetic transmission member 45B lie along the axis of the valve body 33 (driven rotating body 46B) of the expansion valve 13. The driving rotating body 44A, the magnetic transmission member 45A, the driven rotating body 46A, the driving rotating body 44B, and the magnetic transmission member 45B are arranged in this order at the lower side of the electric driving unit 42.

The electric driving unit 42 is formed by a stepping motor, a brushless motor, a brush motor, or the like. The electric driving unit 42 is connected to the circuit board 47 by a connection terminal 42x and supplied with power from the circuit board 47 via the connection terminal 42x. The electric driving unit 42 is rotated and driven by the power supplied from the circuit board 47 (control circuitry) to rotate a rotary shaft 42a. The electric driving unit 42 includes a detected body (sensor magnet) 48 that is rotated integrally with the rotary shaft 42a. The circuit board 47 includes a position detection unit (Hall IC) 49 that detects the detected body 48 to obtain rotation information (i.e., rotational position and speed) on the rotary shaft 42a. The rotary shaft 42a of the electric driving unit 42 projects downward from the main body and is connected to the driving rotating body 44A of the first magnetic speed reduction unit 43A to be rotatable integrally with the first magnetic speed reduction unit 43A.

The first magnetic speed reduction unit 43A and the second magnetic speed reduction unit 43B are magnetic speed reducers. The driving rotating bodies 44A, 44B are identical in structure. The magnetic transmission members 45A, 45B are identical in structure. The driven rotating bodies 46A, 46B are identical in structure. The first magnetic speed reduction unit 43A and the second magnetic speed reduction unit 43B serve as magnetic couplings. The first magnetic speed reduction unit 43A is a first-stage magnetic speed reducer that reduces the speed of the rotation of the rotary shaft 42a of the electric driving unit 42 and generates high torque. The second magnetic speed reduction unit 43B is a second-stage (final stage) magnetic speed reducer that reduces the speed of the rotation of an output shaft 43x of the first magnetic speed reduction unit 43A and generates high torque. The rotation of the rotary shaft 42a is transmitted to the valve body 33 via the first magnetic speed reduction unit 43A and the second magnetic speed reduction unit 43B. The driving rotating bodies 44A, 44B, the magnetic transmission members 45A, 45B, and the driven rotating bodies 46A, 46B are arranged coaxially with the rotary shaft 42a and the valve body 33 so as to lie on the axis of the rotary shaft 42a of the electric driving unit 42 and the valve body 33.

The magnetic transmission member 45A is arranged at the lower side of the driving rotating body 44A that rotates integrally with the rotary shaft 42a. The driven rotating body 46A is arranged at the lower side of the magnetic transmission member 45A. The driving rotating body 44A has a magnetic opposing surface 44x that faces the upper surface of the magnetic transmission member 45A. The driven rotating body 46A has a magnetic opposing surface 46x that faces the lower surface of the magnetic transmission member 45A. The magnetic transmission member 45B is arranged at the lower side of the driving rotating body 44B that rotates integrally with the driven rotating body 46A. The driven rotating body 46B is arranged at the lower side of the magnetic transmission member 45B. The driving rotating body 44B has a magnetic opposing surface 44x that faces the upper surface of the magnetic transmission member 45B. The driven rotating body 46B has a magnetic opposing surface 46x that faces the lower surface of the magnetic transmission member 45B and sandwiches the closure plate 34 with the lower surface of the magnetic transmission member 45B.

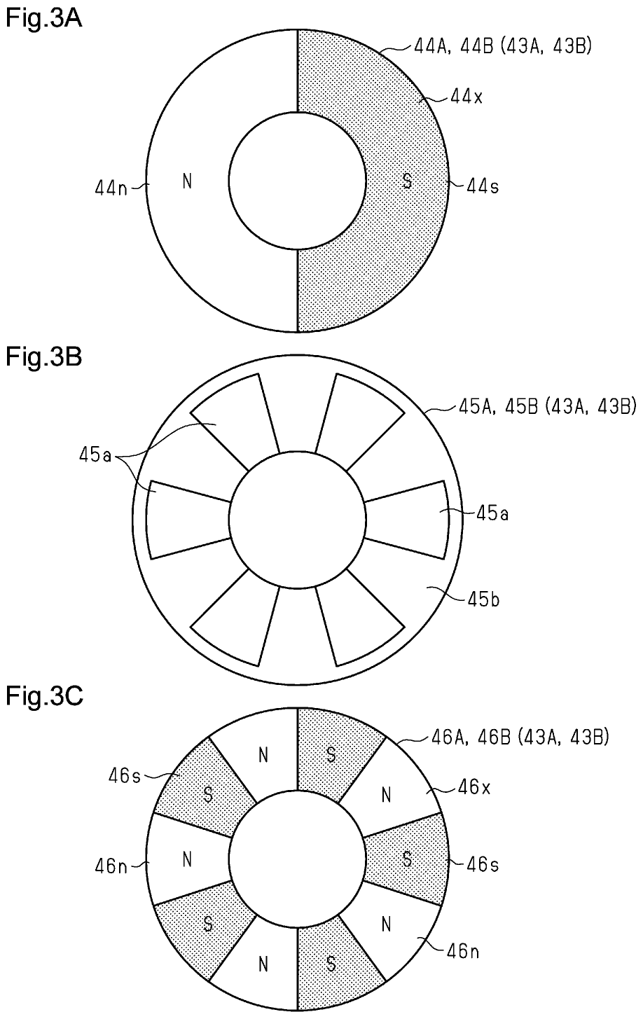

The driving rotating bodies 44A, 44B, formed by common members, each include the magnetic opposing surface 44x. As shown in FIG. 3A, each magnetic opposing surface 44x includes two magnetic poles, more specifically, an N magnetic pole 44n and an S magnetic pole 44s arranged in its outer annular region. The N magnetic pole 44n and the S magnetic pole 44s are arranged at equal angular intervals and extend in an angular range of 180°. The driving rotating bodies 44A, 44B are fixed coaxially with the rotary shaft 42a of the electric driving unit 42 so that the magnetic opposing surfaces 44x are directed downward (refer to FIG. 2).

The magnetic transmission members 45A, 45B are formed by common members. As shown in FIG. 3B, the magnetic transmission members 45A, 45B include six magnetic transmission bodies 45a arranged in its outer annular region on the upper surfaces. The six magnetic transmission bodies 45a face the magnetic poles 44n, 44s of the driving rotating bodies 44A, 44B in the axial direction. The six magnetic transmission bodies 45a are made of a magnetic metal. The six magnetic transmission bodies 45a are spaced apart from each other at equal intervals and integrally incorporated in a plastic (non-magnetic) base member 45b. The magnetic transmission bodies 45a are each formed by magnetic metal plates stacked in the axial direction and incorporated in the base member 45b through insert molding or as separately coupled bodies. The magnetic transmission bodies 45a are each sectoral and extend in an angular range of 30°. The magnetic transmission bodies 45a are arranged so that the interval between adjacent magnetic transmission bodies 45a corresponds to 30°. In other words, the magnetic transmission members 45A, 45B include magnetic portions, which are formed by the magnetic transmission bodies 45a, and non-magnetic portions, which are formed by the base member 45b, arranged alternately at equal angular intervals and extending in an angular range of 30°.

As shown in FIG. 2, the magnetic transmission member 45B of the second magnetic speed reduction unit 43B is located at the bottom of the housing 40. The bottom of the housing 40 is open and closed by the closure plate 34. The magnetic transmission member 45B is arranged so that its lower surface abuts the upper surface of the closure plate 34. The upper surface of the magnetic transmission member 45B faces the magnetic opposing surface 44x, which is the lower surface of the driving rotating body 44B, spaced apart by a set distance in the axial direction. The lower surface of the magnetic transmission member 45A faces the magnetic opposing surface 46x, which is the upper surface of the driven rotating body 46A, spaced apart by a set distance in the axial direction. The upper surface of the magnetic transmission member 45A faces the magnetic opposing surface 44x, which is the lower surface of the driving rotating body 44A, spaced apart by a set distance in the axial direction.

As shown in FIG. 3C, the magnetic opposing surfaces 46x of the driven rotating bodies 46A, 46B have an outer annular region. The outer annular region of the magnetic opposing surfaces 46x faces the magnetic transmission bodies 45a of the magnetic transmission members 45A, 45B in the axial direction. In the outer annular region of the magnetic opposing surface 46x, a total of ten magnetic poles, more specifically, five N magnetic poles 46n and five S magnetic poles 46s are arranged alternately at equal angular intervals and extend in an angular range of 36°. The driven rotating body 46A is accommodated in the housing 40 near the upper surface of the closure plate 34. The driven rotating body 46B is accommodated in the valve accommodating hole 31d of the base block 31 near the lower surface of the closure plate 34 and is coaxially fixed to the valve body 33.

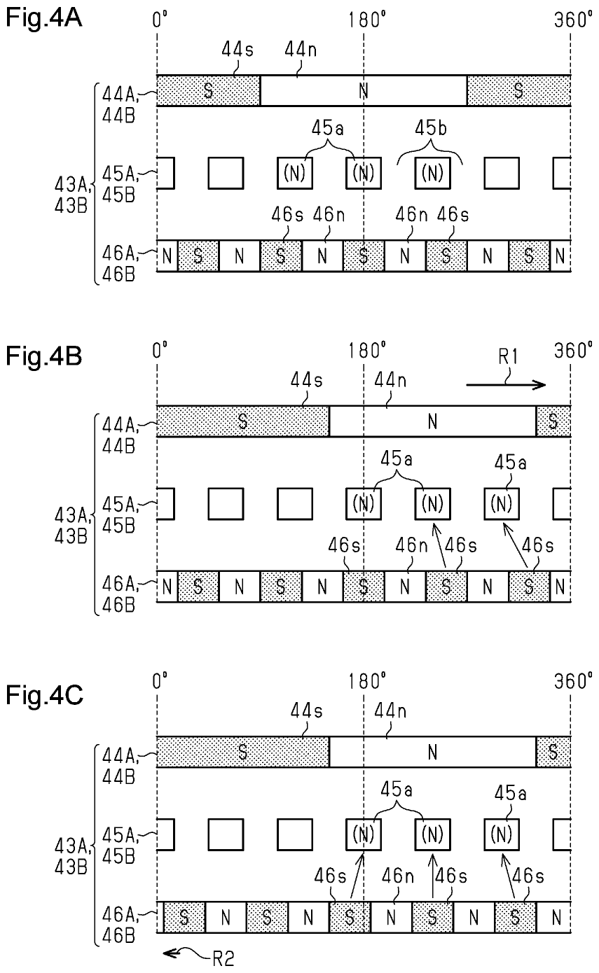

The first and second magnetic speed reduction units 43A, 43B configured in this manner are actuated as shown in FIGS. 4A to 4C. The N magnetic pole 44n of the driving rotating bodies 44A, 44B will now be described in detail. The driving rotating bodies 44A, 44B, the magnetic transmission members 45A, 45B, and the driven rotating bodies 46A, 46B of the present embodiment are configured so that the N magnetic pole 44n of the driving rotating bodies 44A, 44B arranged in the range of 180° corresponds to an angular range of the magnetic transmission members 45A, 45B in which three magnetic transmission bodies 45a (magnetic portions) and three non-magnetic portions therebetween are alternately arranged. The N magnetic pole 44n also corresponds to an angular range of the driven rotating bodies 46A, 46B in which three S magnetic poles 46s and two N magnetic poles 44n are alternately arranged.

The first magnetic speed reduction unit 43A will now be described. In the state shown in FIG. 4A, three magnetic transmission bodies 45a of the magnetic transmission member 45A facing the N magnetic pole 44n of the driving rotating body 44A are each excited by the N-pole. The center of the magnetic pole of the N magnetic pole 44n corresponds to the center of the middle one of the three magnetic transmission bodies 45a. In this state, the three magnetic transmission bodies 45a face three S magnetic poles 46s of the driven rotating body 46A. The center of the middle magnetic transmission body 45a corresponds to the center of the middle one of the three S magnetic poles 46s. That is, FIG. 4A shows a stable state in which rotational force does not act on the driven rotating body 46A. When the electric driving unit 42 drives and rotates the driving rotating body 44A by an amount corresponding to one magnetic transmission body 45a (arrow R1), the state shown in FIG. 4B is obtained.

In the state shown in FIG. 4B, the N magnetic pole 44n of the driving rotating body 44A faces three magnetic transmission bodies 45a that are shifted by one magnetic transmission body 45a from the three magnetic transmission bodies 45a shown in FIG. 4A. The center of the magnetic pole of the N magnetic pole 44n corresponds to the center of the middle one of the three magnetic transmission bodies 45a. In this state, the three magnetic transmission bodies 45a face three S magnetic poles 46s of the driven rotating body 46A. The center of the S magnetic pole 46s located at the end of the three S magnetic poles 46s in the direction opposite to the rotation direction of the driving rotating body 44A corresponds to the center of the corresponding magnetic transmission body 45a. Consequently, as shown in FIG. 4C, rotational force acts on the driven rotating body 46A in the direction opposite to the rotation direction of the driving rotating body 44A so that the center of the middle one of the three S magnetic poles 46s is positioned in correspondence with the center of the middle one of the three magnetic transmission bodies 45a. This rotates the driven rotating body 46A in the direction opposite to the rotation direction of the driving rotating body 44A (arrow R2).

The actions of FIGS. 4A to 4C are illustrated to facilitate the understanding of the rotation principle of the magnetic speed reduction unit 43A (driving rotating body 44A, magnetic transmission member 45A, and driven rotating body 46A). FIG. 4B illustrates the driven rotating body 46A in a stopped state even though the driving rotating body 44A is rotating. Actually, the driven rotating body 46A immediately follows the rotation of the driving rotating body 44A and rotates smoothly. The S magnetic pole 44s is actuated in the same manner as the N magnetic pole 44n.

The above actions are repeated as the driving rotating body 44A continuously rotates. The driven rotating body 46A follows the driving rotating body 44A and rotates in the direction opposite to the driving rotating body 44A. In this case, when the driving rotating body 44A is rotated by an amount corresponding to one magnetic transmission body 45a of the magnetic transmission member 45A, namely, 60°, the driven rotating body 46A is rotated by an amount corresponding to one S magnetic pole 46s, namely, 12° in the opposite direction. In other words, the rotation ratio (speed reduction ratio) of the driving rotating body 44A to the driven rotating body 46A is set to 5:1. The rotation of the driving rotating body 44A is reduced in speed and increased in torque when transmitted to the driven rotating body 46A via the magnetic transmission member 45A.

The second magnetic speed reduction unit 43B will now be described. The second magnetic speed reduction unit 43B is actuated in the same manner as the first magnetic speed reduction unit 43A. The rotation ratio (speed reduction ratio) of the driving rotating body 44B to the driven rotating body 46B is 5:1. The first and second magnetic speed reduction units 43A, 43B are used in two stages in the present embodiment. The rotation ratio (speed reduction ratio) of the driving rotating body 44A of the first magnetic speed reduction unit 43A to the driven rotating body 46B of the second magnetic speed reduction unit 43B is 25:1. This greatly reduces speed and greatly increases torque.

The first and second magnetic speed reduction units 43A, 43B are structured to transmit drive in a non-contact manner through magnetic speed reduction and differ from a structure that transmits drive by reducing speed with a train of meshed gears such as a known reduction gear mechanism. This provides an extremely high level of quietness when transmitting drive. Further, the first and second magnetic speed reduction units 43A, 43B also form a magnetic coupling. This allows the closure plate 34 to be located between the magnetic transmission member 45B and the driven rotating body 46B of the second magnetic speed reduction unit 43B so that the closure plate 34 closes the opening 31f of the valve accommodating hole 31d of the base block 31 in a liquid-tight manner. In other words, the liquid-tight structure formed by the closure plate 34 securely prevents refrigerant from entering the electric driving unit 42 (driving device 32) through a driving transmission path that would have a tendency for allowing the entrance of refrigerant.

In the present embodiment, the magnetic speed reduction mechanism is configured to have two stages to obtain a greater speed reduction ratio without increasing the size (output) of the electric driving unit 42. In the present embodiment, the first and second magnetic speed reduction units 43A, 43B may be formed by members that are identical in structure (common parts). Specifically, the driving rotating bodies 44A, 44B are identical in structure, the magnetic transmission members 45A, 45B are identical in structure, and the driven rotating bodies 46A, 46B are identical in structure. This restricts an increase in the amount of serial number for parts even when used for a multiple-stage speed reduction mechanism.

The circuit board 47 is arranged near the opening 40a of the housing 40. The circuit board 47 includes various types of electronic components (not shown). The circuit board 47 forms control circuitry that controls the driving of the electric driving unit 42. The circuit board 47 is arranged so that its planar direction is orthogonal to the axial direction of the electric driving unit 42.

The control circuitry (circuit board 47) controls the rotation-drive of the electric driving unit 42 and adjusts the extended and retracted positions of the valve body 33 of the expansion valve 13 with the magnetic speed reduction units 43A, 43B to adjust the amount of refrigerant supplied to the evaporator 14. In other words, the control circuitry (circuit board 47) controls the opening and closing of the expansion valve 13 (expansion valve device 30) in cooperation with the integrated valve device 24 of the vehicle air conditioner to control air conditioning with the control circuitry of the integrated valve device 24.

The advantages of the present embodiment will now be described.

(1) The speed reduction unit of the present embodiment has a two-stage structure of the first and second magnetic speed reduction units 43A, 43B. The driving rotating body 44A, the magnetic transmission member 45A, and the driven rotating body 46A, which are the components of the first magnetic speed reduction unit 43A, and the driving rotating body 44B and the magnetic transmission member 45B, which are the components of the second magnetic speed reduction unit 43B, are arranged inside the housing 40 of the driving device 32 partitioned in a liquid-tight manner from the refrigerant passage. Thus, the components inside the housing 40 are not exposed to refrigerant. This avoids corrosion of the components inside the housing 40 that may be caused by water in the refrigerant and would adversely affect smooth movement of the components. Thus, the expansion valve device 30 can be used stably over a long period of time.

(2) In the magnetic speed reduction units 43A, 43B, the driving rotating bodies 44A, 44B each include, for example, two magnetic poles 44n, 44s. The magnetic transmission members 45A, 45B each include, for example, six magnetic transmission bodies 45a. The driven rotating bodies 46A, 46B each include, for example, ten magnetic poles 46n, 46s. The setting of such numbers allow for magnetic speed reduction in the magnetic speed reduction units 43A, 43B. Such magnetic speed reduction units 43A, 43B transmit rotation in a non-contact manner from the driving rotating bodies 44A, 44B to the driven rotating bodies 46A, 46B through the magnetic transmission members 45A, 45B. Thus, the expansion valve device 30 will have a high level of quietness.

(3) The expansion valve device 30 includes the two stages of the first and second magnetic speed reduction units 43A, 43B. This allows the expansion valve device 30 to have a high gear ratio. In the present embodiment, the two driving rotating bodies 44A, 44B are identical in structure, the two magnetic transmission members 45A, 45B are identical in structure, and the two driven rotating bodies 46A, 46B are identical in structure. Thus, common parts can be used. This limits an increase in the amount of serial number for parts.

(4) The opening 31f of the valve accommodating hole 31d is closed by closure plate 34 in a liquid-tight manner. The closure plate 34 is located between the magnetic transmission member 45B and the driven rotating body 46B of the second magnetic speed reduction unit 43B to partition the magnetic transmission member 45B and the driven rotating body 46B from each other. The magnetic speed reduction unit 43B, which also forms the magnetic coupling, and the closure plate 34 prevent refrigerant from entering the housing 40 of the driving device 32. The magnetic transmission member 45B and the magnetic transmission member 45A of the first magnetic speed reduction unit 43A, made of a magnetic metal, are not corroded by the water in the refrigerant.

(5) The driving rotating body 44A, the magnetic transmission member 45A, and the driven rotating body 46A of the magnetic speed reduction unit 43A face each other in the axial direction. The driving rotating body 44B, the magnetic transmission member 45B, and the driven rotating body 46B of the magnetic speed reduction unit 43B face each other in the axial direction. This reduces the size of the magnetic speed reduction units 43A, 43B in the direction orthogonal to the axis (radial direction), thereby allowing for reduction in size of the driving device 32 (expansion valve device 30) in the radial direction. The components face each other in the axial direction. This allows the closure plate 34 to be located between the magnetic transmission member 45B and the driven rotating body 46B like in the present embodiment. Thus, the closure plate 34 may be flat like in the present embodiment.

(6) The magnetic transmission bodies 45a of the magnetic transmission members 45A, 45B are integrally incorporated in the plastic base member 45b. This facilitates handling of the magnetic transmission members 45A, 45B and coupling to the expansion valve device 30 (driving device 32).

(7) The rotation of the electric driving unit (motor) 42 from the second magnetic speed reduction unit 43B is converted into linear actions (forward and backward actions) of the valve body 33 by the thread mechanism (external thread 33b and internal thread 31e). This applies attraction force, which is generated by the magnetic speed reduction unit 43B (more specifically, attraction force in driving rotating body 44B, magnetic transmission member 45B, and driven rotating body 46B), to the thread mechanism (threads 33b, 31e) that has a loose structure. Thus, looseness in the thread mechanism (threads 33b, 31e) and looseness in the valve body 33 are reduced without using an urging member.

(8) The base block 31 includes the inlet path 31a, which is part of the circulation path of the refrigeration cycle system D, and accommodates the expansion valve 13. The driving device 32 is integrally fixed to the base block 31 to form a unit. This improves the coupling characteristics and the like of the expansion valve device 30.

(9) In the housing 40, the distance between the circuit board 47 and the base block 31 is greater than the distance between the electric driving unit 42 and the base block 31. That is, the circuit board 47 is arranged at a position (near opening 40a) spaced apart from the base block 31, which includes the circulation path of refrigerant. The circuit board 47, which is arranged at the upper side, prevents refrigerant, which may enter the housing 40, from reaching the circuit board 47 and avoids damage to the circuit board 47.

The present embodiment may be modified as described below. The present embodiment and the following modifications can be combined as long as the combined modifications are not in contradiction.

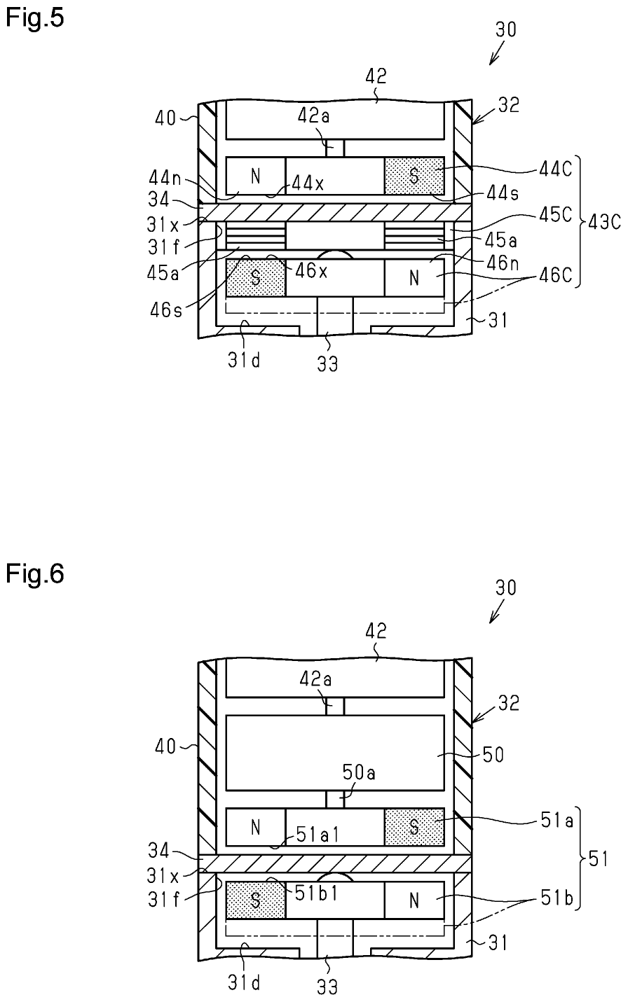

The first and second magnetic speed reduction units 43A, 43B are used in two stages. Instead, the stage magnetic speed reduction units may be used in three or more stages. In this case, preferably, the driving rotating bodies, the magnetic transmission members, and the driven rotating bodies arranged in pairs may be identical in structure (common parts) to limit an increase in the amount of serial number for parts. Alternatively, a magnetic speed reduction unit 43C may be formed to have a single stage as shown in FIG. 5. The magnetic speed reduction unit 43C may include a driving rotating body 44C, a magnetic transmission member 45C, and a driven rotating body 46C having the structures described above. Further, as shown in FIG. 5, the magnetic transmission member 45C may be accommodated in the valve accommodating hole 31d in the same manner as the driven rotating body 46C. In this case, the magnetic transmission member 45C preferably undergoes to a surface treatment that improves the resistance to refrigerant. In FIG. 5, the driving rotating body 44C is not exposed to refrigerant and is not deteriorated by refrigerant.

In the magnetic speed reduction structure, the driving rotating bodies 44A, 44B each include two magnetic poles 44n, 44s, the magnetic transmission members 45A, 45B each include six magnetic transmission bodies 45a, and the driven rotating bodies 46A, 46B each include ten magnetic poles 46n, 46s. However, these numbers are examples and may be changed.

Although not particularly specified above, the magnetic poles 44n, 44s, 46n, 46s arranged on the magnetic opposing surfaces 44x, 46x of the driving rotating bodies 44A, 44B and the driven rotating bodies 46A, 46B may be formed by polar anisotropic magnets having magnetic poles formed mainly in the magnetic opposing surfaces 44x, 46x. The polar anisotropic magnets eliminate the need of a back yoke in the driving rotating bodies 44A, 44B and the driven rotating bodies 46A, 46B. Thus, the number of parts can be reduced. Magnetic poles of other structures may be used such as typical axial-direction-oriented magnets so that the magnetic poles are formed in the front and rear surfaces of the driving rotating bodies 44A, 44B and the driven rotating bodies 46A, 46B.

The magnetic transmission bodies 45a of the magnetic transmission members 45A, 45B are integrally incorporated in the plastic base member 45b. However, the structure may be changed so that the magnetic transmission bodies 45a are separately arranged.

The driving rotating bodies 44A, 44B, the magnetic transmission members 45A, 45B, and the driven rotating bodies 46A, 46B face each other in the axial direction but may face each other in the radial direction may be used. In this case, the shape of the closure plate 34 needs to be changed so that part of the closure plate 34 is located between, for example, the magnetic transmission member 45B and the driven rotating body 46B faced in the radial direction.

The magnetic speed reduction units 43A, 43B reduce rotation caused by the driving of the electric driving unit (motor) 42. Instead, the magnetic speed reduction units 43A, 43B may be applied to a magnetic transmission unit including a magnetic speed increasing unit for increasing the speed of the rotation generated when driving of the electric driving unit (motor) 42.

Instead of the magnetic speed reduction units 43A, 43B, a reduction gear unit 50 shown in FIG. 6 may be used to mechanically reduce speed with a train of meshed gears. The reduction gear unit 50 serves as a transmission unit (gear transmission unit). In FIG. 6, a magnetic coupling 51 is arranged at a stage following the reduction gear unit 50 (in driving transmission path for expansion valve 13 (valve body 33)). The magnetic coupling 51 includes a driving rotating body 51a, coaxially fixed to an output shaft 50a of the reduction gear unit 50, and a driven rotating body 51b, coaxially fixed to the valve body 33. The driving rotating body 51a and the driven rotating body 51b face each other in the axial direction and are magnetically coupled by magnetic opposing surfaces 51a1, 51b1. The closure plate 34 partitions the driving rotating body 51a and the driven rotating body 51b from each other in a liquid-tight manner. In other words, the partition between the driving rotating body 51a and the driven rotating body 51b of the magnetic coupling 51 prevents refrigerant from entering the housing 40 of the driving device 32 in a driving transmission path from which the refrigerant may enter so that the refrigerant does not remove grease from meshed parts of the reduction gear unit 50 and does not hinder smooth movement in the speed reduction unit 50. The reduction gear unit 50 is used as a gear transmission unit. Alternatively, a speed increasing gear unit may be used.

The circuit board 47 is arranged near the opening 40a of the housing 40 above the electric driving unit 42. Instead, the circuit board 47 may be arranged so that its planar direction conforms to the vertical direction. In this case, the circuit board 47 may be arranged along the side surface of the housing 40.

The expansion valve device 30 includes the base block 31 at the lower side and the driving device 32 at the upper side. However, the arrangement may be changed.

The present disclosure may be applied to a valve other than the expansion valve device 30 (expansion valve 13) such as the integrated valve device 24 in the refrigeration cycle system D of the present embodiment.

The present disclosure is applied to the refrigeration cycle system D for vehicle air conditioning. Instead, the present disclosure may be applied to a valve device used in a refrigerant circulation path of other refrigeration cycle systems such as a refrigeration cycle system for air conditioning in situations for use in non-vehicle devices and a refrigeration cycle system for use in non-air conditioning purposes such as battery cooling.

While the present disclosure is described with reference to examples, the present disclosure is not limited to the example or the configuration of the example. The present disclosure includes various variations and modifications within an equivalent range. In addition, various combinations and forms and other combinations and forms, which include only one element or more, shall be within the scope or a range of ideas of the present disclosure.

1. A valve device comprising:
a valve that changes a circulation mode of refrigerant flowing through a circulation path of a refrigeration cycle system;
a driving device that drives the valve, the driving device including a housing and an electric driving unit as a drive source; and
a transmission unit arranged in a driving transmission path extending from the electric driving unit to the valve, wherein the transmission unit changes a speed of rotation generated by driving of the electric driving unit,
wherein the transmission unit is entirely or partially arranged in the housing that is partitioned from the circulation path in a liquid-tight manner.

2. The valve device according to claim 1, wherein
the transmission unit includes a magnetic transmission unit including a driving rotating body, a magnetic transmission member, and a driven rotating body,
the driving rotating body is rotated when driven by the electric driving unit and includes magnetic poles in a rotation direction,
the magnetic transmission member includes magnetic transmission bodies that are excited by the magnetic poles, wherein the magnetic transmission bodies are spaced apart from each other in the rotation direction,
the driven rotating body includes magnetic poles in the rotation direction and is rotated following a rotation action of the magnetic poles of the driving rotating body through the magnetic transmission bodies, and
the magnetic transmission unit is configured to reduce or increase the speed of the rotation by having the magnetic poles and the magnetic transmission bodies differ in number.

3. The valve device according to claim 2, wherein
the driving rotating body is one of stages of driving rotating bodies, wherein the stages of driving rotating bodies include a former stage driving rotating body and a final stage driving rotating body,
the magnetic transmission member is one of stages of magnetic transmission members, wherein the stages of magnetic transmission members include a former stage magnetic transmission member and a final stage magnetic transmission member,
the driven rotating body is one of stages of driven rotating bodies, wherein the stages of driven rotating bodies include a former stage driven rotating body and a final stage driven rotating body,
the transmission unit is one of stages of transmission units, wherein the stages of transmission units include the former stage driving rotating body, the final stage driving rotating body, the former stage magnetic transmission member, the final stage magnetic transmission member, the former stage driven rotating body, and the final stage driven rotating body,
the former stage driven rotating body and the final stage driving rotating body are coupled in a manner allowing for driving,
the former stage driving rotating body and the final stage driving rotating body are identical in structure,
the former stage magnetic transmission member and the final stage magnetic transmission member are identical in structure, and
the former stage driven rotating body and the final stage driven rotating body are identical in structure.

4. The valve device according to claim 2, further comprising:
a base block that partially forms the circulation path and includes a valve accommodating hole that accommodates a valve body of the valve; and
a closure plate that closes an opening of the valve accommodating hole in a liquid-tight manner,
wherein a group that includes the driving rotating body and the magnetic transmission member is partitioned from the driven rotating body by the closure plate.

5. The valve device according to claim 3, further comprising:
a base block that partially forms the circulation path and includes a valve accommodating hole that accommodates a valve body of the valve; and
a closure plate that closes an opening of the valve accommodating hole in a liquid-tight manner,
wherein a group that includes the final stage driving rotating body and the final stage magnetic transmission member is partitioned from the final stage driven rotating body by the closure plate in the stages of transmission units.

6. The valve device according to claim 1, wherein
the transmission unit includes a gear transmission unit that reduces or increases the speed of the rotation by a train of meshed gears,
a magnetic coupling including a driving rotating body and a driven rotating body that are magnetically coupled to each other is arranged in the driving transmission path between the transmission unit and the valve,
the driving rotating body is located closer to the transmission unit than the driven rotating body,
the driven rotating body is located closer to the valve than the driving rotating body, and
the driving rotating body and the driven rotating body are partitioned in a liquid-tight manner.

7. The valve device according to claim 1, wherein the refrigeration cycle system includes a vehicle refrigeration cycle system installed in a vehicle.
